(19) United States
(12) Patent Application Publication
(10) Pub. No.: US 2026/0134880 A1
(43) Pub. Date: May 14, 2026

(54) TALKER POSITION DETECTION METHOD, TALKER POSITION DETECTION APPARATUS, AND NON-TRANSITORY COMPUTER-READABLE STORAGE MEDIUM STORING TALKER POSITION DETECTION PROGRAM

(71) Applicant: Yamaha Corporation, Hamamatsu-shi (JP)

(72) Inventors: Masanobu ANDO, Hamamatsu-shi (JP); Akio Yamane, Hamamatsu-shi (JP)

(21) Appl. No.: 19/441,144

(22) Filed: Jan. 6, 2026

Related U.S. Application Data
(63) Continuation of application No. PCT/JP2024/021660, filed on Jun. 14, 2024.

(30) Foreign Application Priority Data
Jul. 28, 2023 (JP) 2023-123337

(51) Int. Cl. G10L 25/03; G06V 40/16; H04N 23/611; H04N 23/67

(52) U.S. Cl. CPC G10L 25/03; G06V 40/16; H04N 23/611; H04N 23/67

(57) ABSTRACT

A talker position detection method includes acquiring a voice of a talker with a microphone. The talker position detection method also includes determining direction information on a direction of the talker based on the acquired voice of the talker. The talker position detection method also includes obtaining a facial image of the talker based on the determined direction information and an image captured by a camera. The talker position detection method also includes detecting position information on a position of the talker based on the obtained facial image of the talker. The detected position information includes height information on the talker.

### CROSS-REFERENCE TO RELATED APPLICATIONS

The present application is a continuation application of International Application No. PCT/JP2024/021660, filed Jun. 14, 2024, which claims priority to Japanese Patent Application No. 2023-123337, filed Jul. 28, 2023. The contents of these applications are incorporated herein by reference in their entirety.

### BACKGROUND

The present disclosure relates to a talker position detection method, a talker position detection apparatus, and a non-transitory computer-readable storage medium storing a talker position detection program.

JP 1999-041577 A (JP H11-041577 A) discloses a method for determining the position of a talker, involving: processing an input signal from one of a television camera, an ultrasonic sensor, an infrared sensor, or other such element to detect the position of a person; processing an input signal from a microphone array to detect the location of a sound source; and processing these two types of information in a combined manner to determine the position of the talker.

The determination method disclosed in JP 1999-041577 A does not take into account information on the height of the talker and therefore does not enable the position of the talker to be uniquely determined on a camera image.

As such, an object of the present disclosure is to provide a talker position detection method, talker position detection apparatus, and talker position detection program that enable the position of a talker to be uniquely determined.

### SUMMARY

One aspect is a talker position detection method that includes acquiring a voice of a talker with a microphone. The talker position detection method also includes determining direction information on a direction of the talker based on the acquired voice of the talker. The talker position detection method also includes obtaining a facial image of the talker based on the determined direction information and an image captured by a camera. The talker position detection method also includes detecting position information on a position of the talker based on the obtained facial image of the talker. The detected position information includes height information on the talker.

Another aspect is a talker position detection apparatus that includes a microphone, a camera, and a processor. The processor is configured to acquire a voice of a talker with the microphone. The processor is also configured to determine direction information on a direction of the talker based on the acquired voice of the talker. The processor is also configured to obtain a facial image of the talker based on the determined direction information and an image captured by the camera. The processor is also configured to detect position information on a position of the talker based on the obtained facial image of the talker. The detected position information includes height information on the talker.

Another aspect is a non-transitory computer-readable storage medium storing a talker position detection program executable by at least one processor of an information processing device to execute a method including acquiring a voice of a talker with a microphone. The method also includes determining direction information on a direction of the talker based on the acquired voice of the talker. The method also includes obtaining a facial image of the talker based on the determined direction information and an image captured by a camera. The method also includes detecting position information on a position of the talker based on the obtained facial image of the talker. The detected position information includes height information on the talker.

A talker position detection method, a talker position detection apparatus, and a talker position detection program according to present disclosure enable the position of a talker to be uniquely determined.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a block diagram illustrating the configuration of a talker position detection apparatus 1;

FIG. 2 shows an elevational view of the interior of a room, in which the talker position detection apparatus 1 is disposed;

FIG. 3 shows a top plan view of the interior of the room, in which the talker position detection apparatus 1 of FIG. 2 is disposed;

FIG. 4 is a flowchart of the operation of a processor 12;

FIG. 5 shows an example user interface presented on a display unit;

FIG. 6 shows an example user interface in accordance with an alternative embodiment;

FIG. 7 shows an example user interface indicating a non-focus region;

FIG. 8 shows an example user interface in accordance with another alternative embodiment;

FIG. 9 shows an example user interface in accordance with yet another alternative embodiment;

FIG. 10 shows an example user interface in accordance with yet another alternative embodiment;

FIG. 11 shows an elevational view of the interior of a room, in which a talker position detection apparatus 1 in accordance with yet another alternative embodiment is disposed;

FIG. 12 shows an elevational plan view of the interior of the room, in which the talker position detection apparatus 1 of FIG. 11 is disposed;

FIG. 13 shows an example user interface in accordance with yet another alternative embodiment;

FIG. 14 shows the example user interface of FIG. 13; and

FIG. 15 shows an example user interface presented on a display unit.

### DETAILED DESCRIPTION

The present specification is applicable to a talker position detection method, a talker position detection apparatus, and a non-transitory computer-readable storage medium storing a talker position detection program.

The embodiments will now be described with reference to the accompanying drawings, wherein like reference numerals designate corresponding or identical elements throughout the various drawings. The embodiments presented below serve as illustrative examples of the present disclosure and are not intended to limit the scope of the present disclosure. In the accompanying drawings referenced in the embodiments, similar reference numerals, characters, or symbols may be used to indicate corresponding or identical elements. For example, to distinguish like elements, “A” may be appended to a reference numeral and “B” may be appended to the same reference numeral.

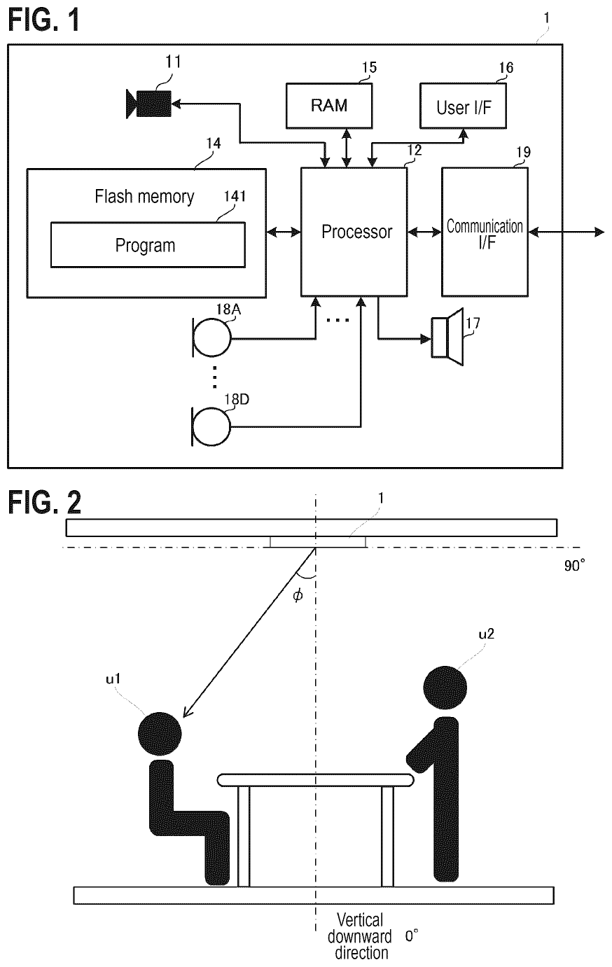

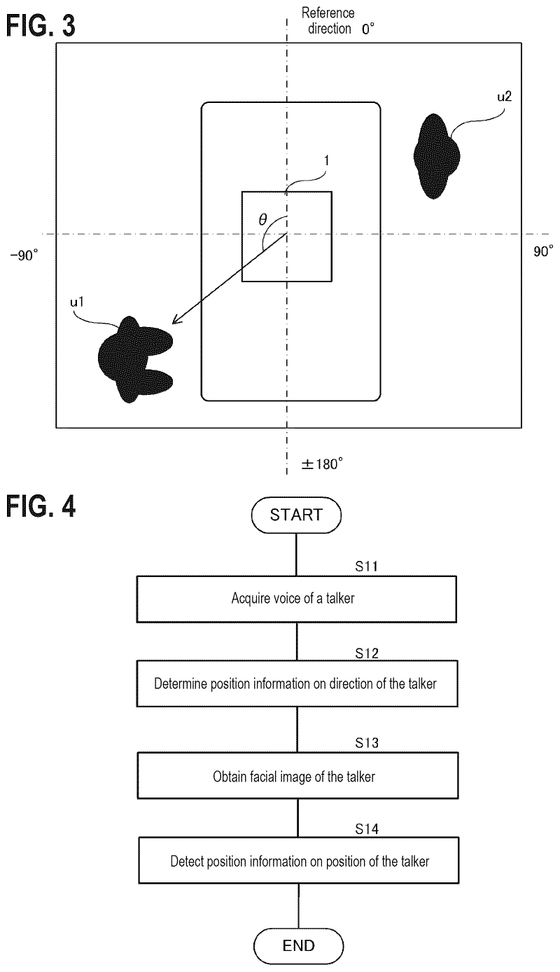

FIG. 1 is a block diagram illustrating the configuration of a talker position detection apparatus 1. FIGS. 2 and 3 respectively show a schematic elevational view and a schematic top plan view of the interior of a room, in which the talker position detection apparatus 1 is disposed.

The talker position detection apparatus 1 includes a camera 11, a processor 12, a flash memory 14, a RAM 15, a user I/F (or interface) 16, a speaker 17, a plurality of microphones 18A to 18D, and a communication I/F 19.

The talker position detection apparatus 1 is disposed at the ceiling of the interior of the room. The talker position detection apparatus 1 has a thin rectangular housing. In the instant embodiment, the talker position detection apparatus 1 is disposed on the ceiling. The camera 11, the speaker 17, and the microphones 18A to 18D are located in the housing.

A table is disposed directly below the housing of the talker position detection apparatus 1. In the example of FIGS. 2 and 3, more than one user (or users u1 and u2) is present around the table.

It should be understood that the present disclosure does not require the camera 11, the speaker 17, and the microphones 18A to 18D to be disposed at the ceiling. According to one example of the present disclosure, the microphones 18A to 18D may be disposed at the ceiling while the camera 11 and the speaker 17 may be set on the table.

The camera 11 acquires an image of a user. The microphones 18A to 18D acquire the voice of the user. The speaker 17 emits sound to the user.

In the instant embodiment, there are four microphones constituting an array of microphones. However, there may be fewer or more than four microphones.

The processor 12 loads an operational program from the flash memory 14 into the RAM 15, making the processor 12 a controller that implements integrated control of the operation of the talker position detection apparatus 1. In one example, the flash memory 14 stores a program 141. The processor 12 runs the program 141 to carry out a talker position detection method according to the present disclosure. Note that it is not mandatory that the program be stored in the flash memory 14 of the apparatus. The processor 12 may alternatively download the program as needed from a server, for example, and load the program into the RAM 15.

The processor 12 also serves as a signal processor unit that processes a video signal and a sound signal. The processor 12 performs pan-tilt-zoom processing (which will hereinafter be referred to as PTZ processing) to, for example, provide a facial image of a talker in an expandable way. In one example, the processor 12 may also process and apply masking on the image of one or more non-participants.

Further, the processor 12 handles directivity processing-assisted beam forming. In one example, the beam forming involves a process to form a microphone beam with an improved sensitivity in the direction of a talker by applying delay-and-sum processing that aligns beams from the direction of the talker in phase.

The communication I/F 19 is used to forward video and sound signals processed by the processor 12 to a different device. Examples of the different device include an information processing terminal such as a personal computer used by a user. The information processing terminal (or near-end information processing terminal) may be linked to an information processing terminal (or far-end information processing terminal) on a remote location over a network such as the Internet. The near-end information processing terminal may receive video and sound signals from the talker position detection apparatus 1 and send the received video and sound signals to the far-end information processing terminal. The near-end information processing terminal may also receive video and sound signals from the far-end information processing terminal, and may output the received video signal to a display unit (not shown) and send the received sound signal to the talker position detection apparatus 1. The communication I/F 19 of the talker position detection apparatus 1 is used to feed the received sound signal to the speaker 17. The speaker 17 emits sound associated with the received sound signal. In this way, the talker position detection apparatus 1 can function as a component of a teleconference system for holding a meeting from a remote location.

FIG. 4 is a flowchart of the operation of the processor 12. Firstly, the processor 12 acquires the voice of a talker through the microphones 18A to 18D (at step S11). The processor 12 determines direction information on the direction of the voice from the talker (at step S12). In the example of FIGS. 2 and 3, the processor 12 determines direction information on the direction of the voice from the user u1.

The information on the direction of the talker includes an elevation angle φ relative to a vertical downward direction, which is set at zero degree, and a horizontal angle θ relative to a reference direction as viewed on a top plan view, which is set at zero degree. The processor 12 analyzes sound signals acquired through the microphones 18A to 18D to estimate the incoming direction of the voice. A cross-correlation method, a delay-and-sum method, a multiple signal classification (or MUSIC) method, and/or any other suitable method can be used to analyze the sound signals.

For instance, in a cross-correlation method, the processor 12 calculates the cross-correlations between sound signals from the plurality of microphones. By way of example, the processor 12 determines the peak of the cross-correlation between sound signals from two given microphones. Also, the processor 12 determines the peak of the cross-correlation between sound signals from another two given microphones. On the basis of multiple cross-correlation peaks calculated in this manner, the processor 12 estimates the incoming direction of the voice. In other words, the processor 12 selects two or more pairs from the plurality of microphones to determine the multiple cross-correlation peaks. By way of example, the estimate of the incoming direction of the voice can be described by a spatial vector. The processor 12 compares the estimate of the incoming direction of the voice with the vertical downward direction to determine the elevation angle φ. Also, the processor 12 compares the estimate of the incoming direction of the voice with the reference direction to determine the horizontal angle θ.

Next, the processor 12 obtains the facial image of the talker from an image captured by the camera 11 based on the determined information on the direction of the talker (at step S13). In one example, talker face recognition processing powered by a prescribed algorithm such as a neural network is used to obtain the facial image from the image captured by the camera 11. However, the processor 12 performs the talker face recognition processing only on a part of the image captured by the camera 11 that corresponds to the elevation angle φ and the horizontal angle θ, which are determined by the processing at step S12.

Then, the processor 12 detects information on the position of the talker, the information including height information on the talker based on the obtained facial image of the talker (at step S14). In one example, the processor 12 detects the information on the position of the talker, the information including the height information on the talker, by using a model that has learned the relationship between the position and size of a facial image of a talker on an image captured by a camera, on one hand, and height information on the talker relative to a floor level, on the other hand. Alternatively, the processor 12 may detect the information on the position of the talker, the information including the height information on the talker, by referring to a table or function describing the relationship between the position and size of a facial image of a talker on an image captured by a camera, on one hand, and height information on the talker relative to a floor level, on the other hand.

In addition or as an alternative, the processor 12 may determine information on a distance to the talker by using a model that has learned the relationship between the position and size of a facial image of a talker on an image captured by a camera, on one hand, and information on a distance to the talker. Alternatively, the processor 12 may determine the information on the distance to the talker, by referring to a table or function describing the relationship between the position and size of a facial image of a talker on an image captured by a camera, on one hand, and information on a distance to the talker. Upon determining the information on the distance to the talker, the processor 12 may use information on the height of a ceiling plane relative to a floor level to convert the information on the distance to the talker into the height information on the talker.

In this way, the processor 12 detects information on the position of the talker, the information including the information on the direction of the talker (or the elevation angle φ and the horizontal angle θ) and the height information on the talker. Traditionally, image processing-based face recognition technique needs the entire area of an image captured by a camera to find the face of a talker and must be able to discriminate the face of the talker from the face of a non-utterer (or non-talker) for recognition. In contrast, the processor 12 of the instant embodiment firstly acquires the information on the direction of the talker based on sound signals and accordingly performs talker face recognition processing exclusively on an area of the image captured by the camera 11 that matches the information on the direction of the talker. Further, the processor 12 of the instant embodiment is freed from having to discriminate the face of the talker from the face of a non-utterer (or non-talker) for recognition. Thus, according to the instant embodiment, the load associated with face recognition processing on the processor 12 is significantly reduced, allowing the processor 12 to quickly and precisely obtain the facial image of a talker and enabling the processor 12 to uniquely determine the position of the talker on an image captured by the camera 11.

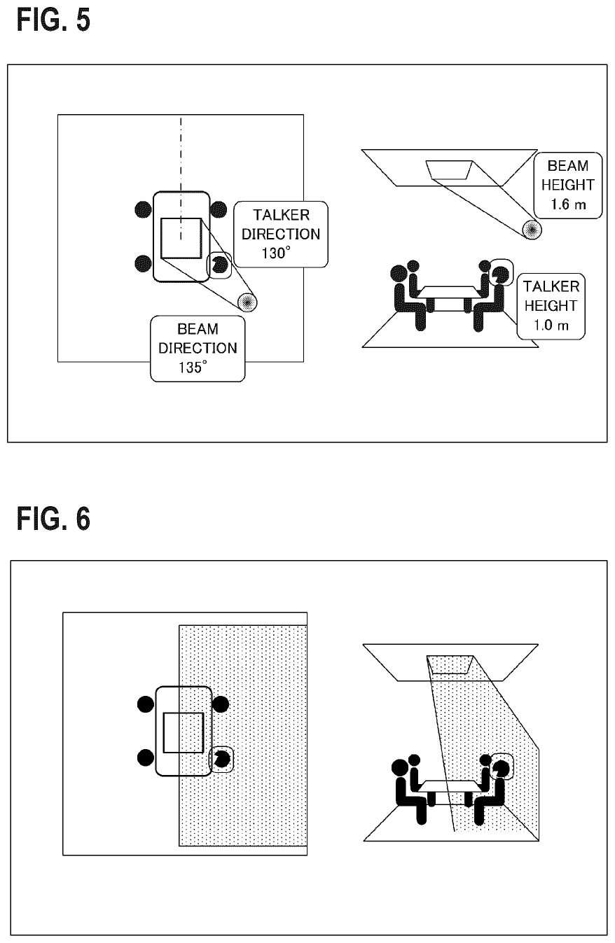

The information on the position of the talker, the information including the height information on the talker, is presented on a display unit of, for example, the near-end information processing terminal. FIG. 5 shows an example user interface presented on the display unit of the near-end information processing terminal. The user interface of FIG. 5 contains representations of a schematic top plan view and a schematic side view of a meeting room. The user interface of FIG. 5 is used by a user to set the focal point of the microphone beam. The focal point of the microphone beam represents one of the non-limiting example configurations of a focus region of the microphones. The user interface of FIG. 5 shows the height and the direction of the location corresponding to the focal point of the microphone beam. In the example of FIG. 5, the direction and the height of the focal point of the microphone beam are set by a user to 135 degrees and 1.6 meters, respectively.

The processor 12 presents a visual indication of the detected information on the position of the talker on the display unit. In the example of FIG. 5, the information on the direction of the talker and the height information on the talker, each of which forms part of the detected information on the position of the talker, indicates a horizontal angle of 130 degrees and a height of 1.0 meter, respectively. The processor 12 presents overlays of the information on the direction of the talker (or a horizontal angle of 130 degrees) and the height information on the talker (or a height of 1.0 meter) on the user interface.

This enables the user to readily acknowledge that there is a deviation of +5 degrees and +0.6 meters in the settings for the horizontal angle and the height of the microphone beam, respectively. That is, a user can enjoy the novel customer experience of being able to readily determine whether the settings for the microphone beam are appropriate or not.

The user can also adjust the settings for the horizontal angle and the height of the microphone beam by −5 degrees and by −0.6 meters, respectively, in order to bring the focal point of the microphone beam to the position of the talker. In other words, a user can enjoy the novel customer experience of being able to easily correct the settings for the microphone beam.

The focal point of the microphone beam represents merely one of the non-limiting example configuration of a focus region of the microphones. A focus region of the microphones may be defined by an operational range of the microphone beam. FIG. 6 shows an example user interface in accordance with such an alternative embodiment.

In the example of FIG. 6, the processor 12 presents a visual indication of an operational range of the microphone beam as a focus region of the microphones. In one example, the operational range of the microphone beam is set by a user through the user I/F 16. The microphone beam is configured with a focal point that can be set only within the set operational range. In this scenario, only the voice of a talker present in the focus region is sampled while the voice of a talker present in a non-focus region, which does not correspond to the focus region, is not sampled.

Accordingly, a user can enjoy the novel customer experience of being able to readily find out a region from which a voice is to be sampled.

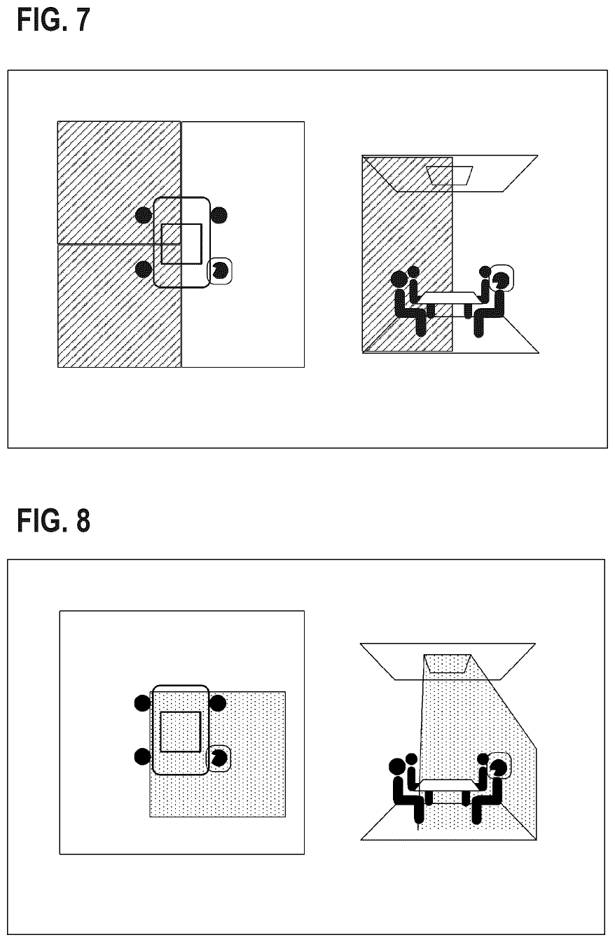

The processor 12 may present a visual indication of a non-operational range of the microphone beam as a non-focus region of the microphones. FIG. 7 shows an example user interface indicating a non-focus region. In the example of FIG. 7, the processor 12 presents a visual indication of a non-operational range of the microphone beam as a non-focus region of the microphones.

In this scenario, a user can enjoy the novel customer experience of being able to readily find out a region from which a voice is not to be sampled.

The processor 12 may also receive focus regions for at least one of the camera or the microphones and obtain an image of the talker based on a focus region that matches the information on the direction of the talker, among the received focus regions. In particular, referring to FIG. 15, the processor 12 may receive first to fourth focus regions to be set as the focus regions for at least one of the camera or the microphones and perform talker face recognition processing on one of the focus regions that matches the information on the direction of the talker (or, in the example of FIG. 15, the fourth focus region). Thus, the load associated with face recognition processing on the processor 12 is significantly reduced, allowing the processor 12 to quickly and precisely obtain the facial image of a talker and enabling the processor 12 to uniquely determine the position of the talker on an image captured by the camera 11.

In another alternative embodiment, the processor 12 determines a focus region for at least one of the camera or the microphones based on the detected information on the position of the talker, and presents a visual indication of the determined focus region and/or a non-focus region, which does not correspond to the determined focus region, on the display unit. FIG. 8 shows an example user interface in accordance with this particular alternative embodiment. In regard to more details on focusing associated with a focus region by the camera, see the discussion below on PTZ processing, which represents an example of the focus control described herein.

The processor 12 may define a prescribed range around the detected position of the talker (or, for example, a square-like range centered on the position of the talker when viewed on a top plan view) as an operational range of the microphone beam and determine the same as a focus region, and present a visual indication of the determined focus region. In this case, an operational range of the microphone beam is set to a prescribed range around the detected position of the talker.

According to this particular alternative embodiment, an operational range of the microphones is set around a talker. Thus, a user can enjoy a novel customer experience of being able to do away with the task of manually setting an operational range of the microphone beam. Further, the processor 12 may define a region, which does not correspond to the focus region, as a non-operational range of the microphone beam and visually indicate the same as a non-focus region. Thus, a user can enjoy the novel customer experience of being able to readily find out a region from which a voice is not to be sampled.

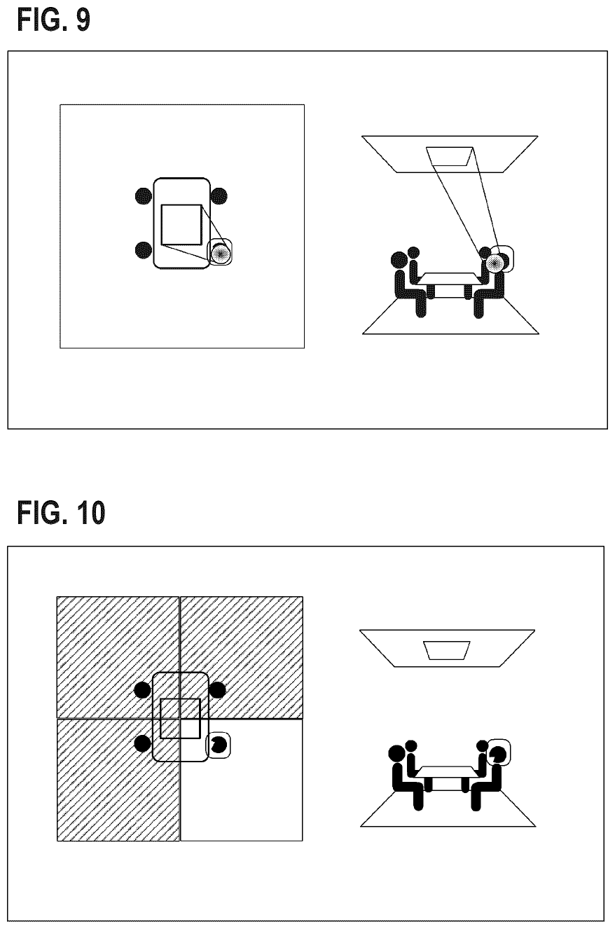

In yet another alternative embodiment, the processor 12 determines a focus region for at least one of the camera or the microphones based on the detected information on the position of the talker, and performs focus control for at least one of the camera or the microphones based on the determined focus region. FIG. 9 shows an example user interface in accordance with this particular alternative embodiment. In regard to more details on focusing associated with a focus region by the camera, see the discussion below on PTZ processing, which represents an example of the focus control described herein.

The processor 12 sets the focal point of the microphone beam on the detected position of the talker as a focus region. Further, the processor 12 presents a visual indication of the focal point of the microphone beam, which has been set as the focus region.

According to this particular alternative embodiment, the focal point of the microphone beam is automatically set on the position of the talker. As a result, the voice of a talker is selectively sampled at a high S/N ratio. Moreover, a user can enjoy the novel customer experience of being able to do away with the task of manually setting the focal point of the microphone beam. Further, a user can enjoy the novel customer experience of being able to direct the focal point of the microphone beam towards his or her position by, for example, just uttering sound.

The focus control for the microphones may involve masking the voice of a person other than the talker. In this particular alternative embodiment, the processor 12 determines a non-focus region for the microphones based on the detected information on the position of the talker, and performs control for masking the voice of a person other than the talker based on the determined non-focus region. FIG. 10 shows an example user interface in accordance with this particular alternative embodiment.

The processor 12 defines a prescribed range around the detected position of the talker as an operational range of the microphone beam and determines the same as a focus region. Further, the processor 12 defines a region, which does not correspond to the focus region, as a non-operational range of the microphone beam and visually indicates the same as a non-focus region, as exemplified by the hatching shown in FIG. 10.

In this scenario, only the voice of a talker present in the focus region is sampled while the voice of a talker present in a non-focus region, which does not correspond to the focus region, is masked, rather than being sampled. Hence, the voice of a talker can be selectively sampled at an even higher S/N ratio. Further, a user can enjoy the novel customer experience of being able to readily find out a region from which a voice is not to be sampled. Moreover, a user can enjoy the novel customer experience of being able to do away with the task of manually setting a non-focus region from which a voice is not to be sampled.

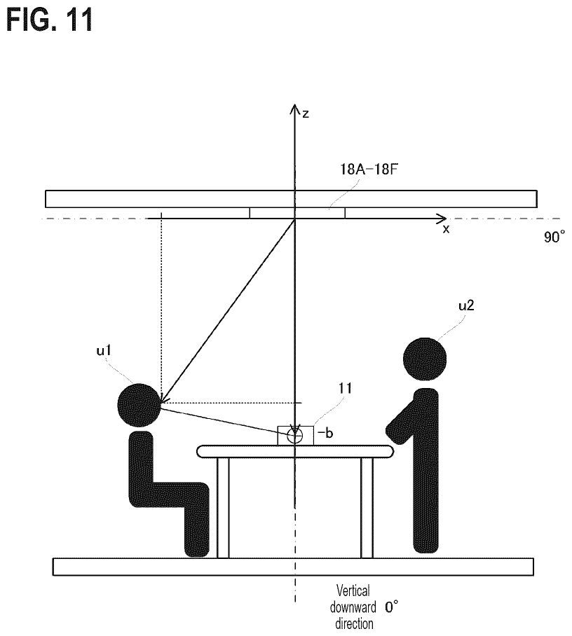

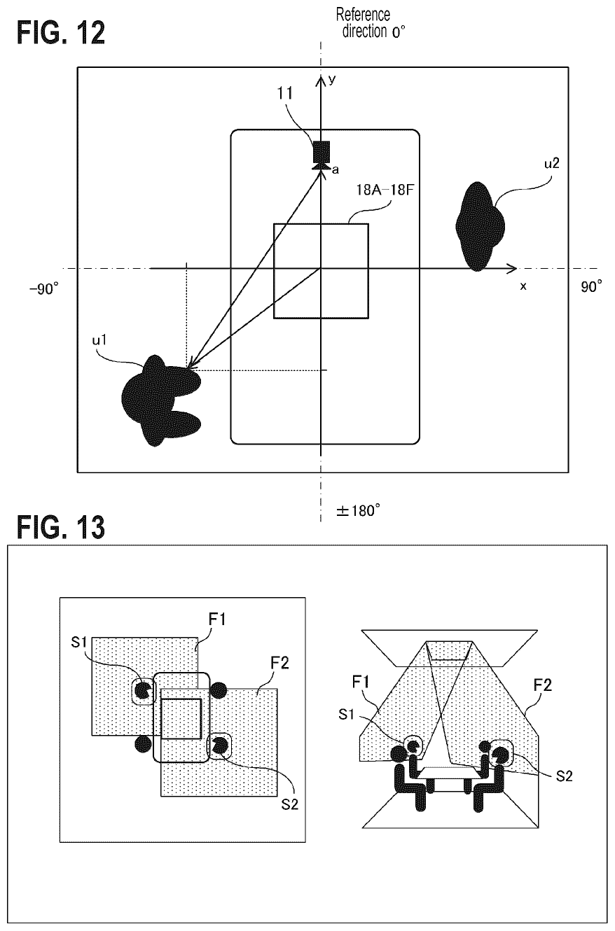

FIG. 11 shows an elevational view of the interior of a room, in which a talker position detection apparatus 1 in accordance with yet another alternative embodiment is disposed, and FIG. 12 shows an elevational plan view of the interior of the room, in which the talker position detection apparatus 1 of FIG. 11 is disposed.

Microphones 18A to 18D of the talker position detection apparatus 1 in accordance with this particular alternative embodiment are disposed at the ceiling of the interior of the room, while a camera 11 is disposed on the table. The remaining features are identical to those shown in FIGS. 2 and 3.

A processor 12 acquires the voice of a talker through the microphones 18A to 18D and determines direction information on the direction of the voice from the talker. Also, the processor 12 acquires relative information on the relative position of the camera 11 and the microphones (or microphones 18A to 18D), and obtains the facial image of the talker from an image captured by the camera 11 based on the relative information on the relative position and the information on the direction of the talker.

In one example, the relative information on the relative position is described by a spatial vector. In the example of FIGS. 11 and 12, the camera 11 is aligned with the microphones laterally (or in the x-axis direction in FIG. 12) and is offset upwards from (or above in the y-axis direction in FIG. 12) the microphones, when viewed in a top plan view (of FIG. 12). In addition, the vertical position of the camera 11 is lower than that of the microphones, when viewed in an elevational view (of FIG. 11). Hence, in one example, the spatial vector describing the relative information on the relative position of the microphones from the camera is expressed as, for example, (x, y, z)=(0, −a, +b). The processor 12 determines a spatial vector indicating the direction of the talker from the camera 11 based on the relative information on the relative position and the spatial vector (or the coordinates of the position of the talker) describing the incoming direction of the voice of the talker based on sampled sound. In the example of FIGS. 11 and 12, the estimate of the incoming direction of the voice based on sound sampled with the microphones can be expressed as (x, y, z)=k (ex, ey, ez) where ex, ey, and ez indicate the components of a unit vector for the estimate (with k being a coefficient that represents a magnitude proportionate to a distance).

The processor 12 substitutes different values for the coefficient k on the unit vector (within the constraints of the distance of, for example, say, 30 centimeters to 3 meters in real space) to capture images at different positions defined as (x, y, z)=(0+k×ex, −a+k×ey, +b+k×ez) with the camera 11, and identifies the talker (or, for example, the face of the talker) from among the captured images to find the value for the coefficient k that corresponds to the position of the talker. For instance, if the face of the talker was detected in the image with the coefficient k=k3, the spatial vector describing the position of the talker relative to the camera 11 would be expressed as (x, y, z)=(0+k3×ex, −a+k3×ey, +b+k3×ez).

The processor 12 performs talker face recognition processing only on a part of the image captured by the camera 11 that corresponds to the spatial vector to the position of the talker.

As such, according to the instant embodiment, even when the camera 11 and the microphones (or microphones 18A to 18D) are arranged at separate positions, the load associated with face recognition processing on the talker position detection apparatus 1 is significantly reduced, allowing the facial image of a talker to be quickly and precisely obtained and enabling the position of the talker to be uniquely determined on an image captured by the camera 11.

In yet another alternative embodiment based on the preceding alternative embodiment, the processor 12 determines an elevation angle, a horizontal angle, and an expansion amount for the camera 11 based on the information on the direction of the talker, the relative information on the relative position, and the height information. The processor 12 performs PTZ processing, which represents an example of the focus control based on the determined elevation angle, horizontal angle, and expansion amount. It should be noted that the PTZ processing may involve physically controlling the imaging direction of the camera 11 and/or controlling an optical zoom lens, and/or may even involve applying signal processing to an image captured through the camera 11. In this way, focusing on the facial image of the talker can be accomplished automatically.

It should be appreciated that, when the camera 11 and the microphones 18A to 18D are arranged in a common housing as shown in FIGS. 2 and 3, the processor 12 may perform PTZ processing by using the information on the direction of the talker (or the horizontal angle θ and the elevation angle φ) and the information on the distance to the talker, each of which is determined, respectively, on the basis of the voice of the talker and on the basis of an image of the talker during the course of determining the information on the position of the talker.

In yet another alternative embodiment, the processor 12 applies masking on the facial image of a person other than the talker. Examples of the masking include blurring, solid fill, replacement with a different image, and any other suitable technique. Additionally or alternatively, the processor 12 may apply masking on the entire area of a non-focus region in an image from the camera 11. In this way, the processor 12 can prevent a person other than a participant in a meeting or other such event from being on a generated image to preserve the privacy of the non-participant without the generated image looking awkward.

The information on the position of the talker may include information on the positions of more than one talker, rather than information on the position of only one talker. In this alternative embodiment, the processor 12 firstly acquires the information on the directions of the talkers based on sound signals and performs talker face recognition processing exclusively on parts of the image captured by the camera 11 that match the information on the directions of the talkers. Further, the processor 12 does not need to discriminate the faces of the talkers from the face of a non-utterer (or non-talker) for recognition. As a result, according to the instant embodiment, the load associated with face recognition processing on the processor 12 is significantly reduced. Thus, according to this particular alternative embodiment, even when the information on the positions of more than one talker is to be detected, the processor 12 can quickly and precisely obtain the facial images of the talkers and uniquely identify the positions of the talkers.

In yet another alternative embodiment, the processor 12 determines, on more than one occasion, a focus region for at least one of the camera or the microphones based on the detected information on the position of the talker, and determines an averaged focus region and/or an averaged non-focus region based on the focus region and/or a non-focus region determined on the more than one occasion.

In this scenario, a focus region and/or a non-focus region is/are progressively optimized according to the position of a talker, as time elapses since the start of a meeting or other such event. Further, a user can enjoy the novel customer experience of being able to do away with the task of manually setting a focus region and/or a non-focus region.

In yet another alternative embodiment, the processor 12 senses the motion of the talker from an image captured by the camera. Examples of the motion of a talker include orientating of a face, and gesture. The processor 12 senses orientating of the face of a talker from an image captured by the camera 11.

In one example, the processor 12 uses a model that has learned the correlation between an image and a movement associated with the gesture, to sense a specific gesture from an image captured by the camera 11.

The processor 12 performs focus control for at least one of the camera or the microphones, according to the sensed motion of a talker. By way of example, the processor 12 changes the direction of the microphone beam to the right of a user when the talker orients his or her face to the right. Also, the processor 12 applies masking on the facial image of a talker when, for example, the talker does the gesture of hiding his or her eyes.

The processor 12 of the instant embodiment firstly acquires the information on the direction of the talker based on sound signals and accordingly performs processing to sense the motion of the talker exclusively on a part of the image captured by the camera 11 that matches the information on the direction of the talker. As a result, according to the instant embodiment, the load associated with talker motion sensing processing on the processor 12 is significantly reduced. Therefore, according to this particular alternative embodiment, the processor 12, despite being tasked with complicated processing such as the sensing of the motion of a talker, can quickly and precisely sense the motion of a talker and perform focus control for at least one of the camera or the microphones according to the motion. Furthermore, a user can enjoy the novel customer experience of being able to control an image and/or the direction of the microphone beam without uttering sound.

In yet another alternative embodiment, the processor 12 determines first information on the position of a first talker and second information on the position of a second talker, determines a first focus region for at least one of the camera or the microphones based on the first information on the position of the first talker, determines a second focus region for at least one of the camera or the microphones based on the second information on the position of the second talker, and sets a third focus region incorporating the first focus region and the second focus region, when a prescribed condition is met.

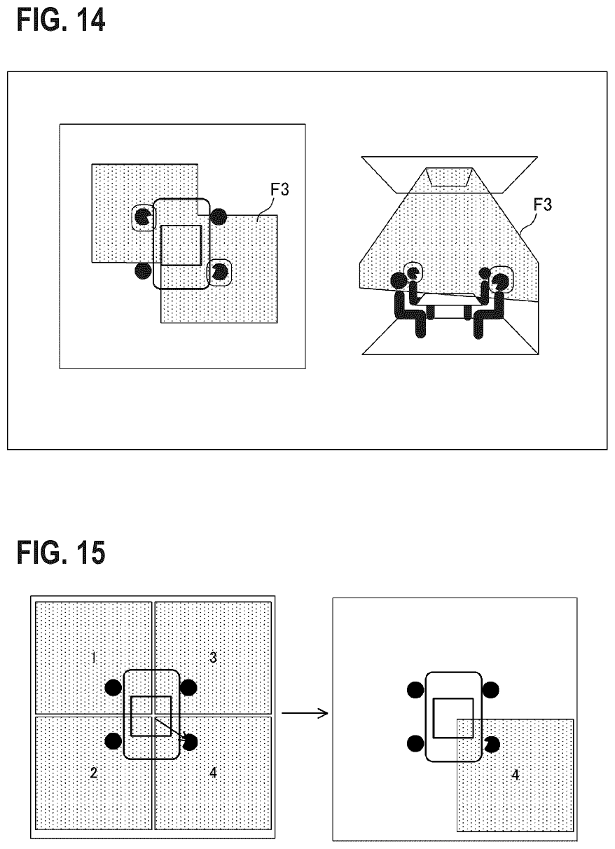

FIGS. 13 and 14 show an example user interface in accordance with this particular alternative embodiment. Referring to FIG. 13, the processor 12 sets a first focus region F1 based on first information on the position of a first talker S1. Also, the processor 12 sets a second focus region F2 based on second information on the position of a second talker S2.

Examples of the prescribed condition include the presence of an overlap between the set focus regions. In the example of FIG. 13, there is an overlap between the first focus region F1 and the second focus region F2 as viewed on a top plan view. In response, the processor 12 sets a third focus region F3 incorporating the first focus region F1 and the second focus region F2, as shown in FIG. 14.

Thus, for example, even when more than one talker is having a conversation, there is no need to update a focus region every time the talkers take turns on a frequent basis, thanks to the common third focus region F3 that is set so as to incorporate the more than one talker. As a result, the load associated with talker position detection processing and focus control on the processor 12 is even more reduced.

In yet another alternative embodiment, the processor 12 detects the start and the end of an event. In one example, the processor 12 detects the start and the end of an event in response to the receipt of an action to start the event and an action to end the event, respectively, through the user I/F 16, or in response to the receipt of an action to turn on the power and an action to turn off the power, respectively, through the user I/F 16.

The processor 12 resets the information on the position of the talker upon detecting the end of the event. The processor 12 determines renewed information on the direction of a talker based on the voice of the talker, which is acquired concurrently upon detecting the start of the event, to newly obtain the facial image of the talker from the image captured by the camera 11 based on the renewed information on the direction of the talker and to detect information on the position of the talker based on the newly obtained facial image of the talker. In other words, the processor 12 resets the information on the position of the talker at the end of the event and detects updated information on the position of a talker at the start of a next event.

In this way, at each event, the processor 12 can newly determine the position of a talker regardless of a change in the environment between events and optimize a focus region and/or a non-focus region according to the position of the talker as a meeting or other such event progresses.

In yet another alternative embodiment, the processor 12 detects the environment of the event based on the voice acquired with the microphones and the image captured by the camera.

Examples of the environment of the event include the place of a meeting, the number and positions of participants in the meeting, and whether the meeting is outdoor, indoor, private, or semi-private. As a result, a user can enjoy the novel customer experience of being able to do away with the task of, for example, manually registering the positions of participants in advance.

The description of the embodiments should be considered illustrative and not restrictive in all respects, and the scope of the present disclosure is to be defined not by the foregoing embodiments but by the appended claims. Moreover, the scope of the present disclosure shall encompass everything that comes within the breadth of equivalency of the claims.

For instance, a meeting is merely one of the non-limiting examples of the event described herein. Other examples of the event include live performance at a concert or other such occasion.

It is worthwhile to note that a storage medium storing a talker position detection program represented by software for realizing the present disclosure can be loaded into an information processing device or an associated memory to produce similar advantages according to the present disclosure. In that case, the program code read from the storage medium implements a set of novel functions of the present disclosure, and the non-transitory, computer-readable storage medium storing the program code forms one aspect of the present disclosure. In some examples, the program code may also be conveyed on a propagation medium. In that case, the program code itself forms another aspect of the present disclosure. It should be noted that examples of the storage medium that can be adopted in these situations include a ROM, a diskette, a hard disk, an optical disk, a magneto-optical disk, a CD-ROM, a CD-R, a magnetic tape, and a non-volatile memory card. Examples of the non-transitory, computer-readable storage medium can even encompass those entities that retain the program for some duration of time, such as volatile memories (e.g., a DRAM (or Dynamic Random Access Memory)) within a computer system that serves as a server and/or client used to transmit the program over a network such as the Internet and/or a communication line such as a telephone line.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. A talker position detection method comprising:
acquiring a voice of a talker with a microphone;
determining direction information on a direction of the talker based on the acquired voice of the talker;
obtaining a facial image of the talker based on the determined direction information and an image captured by a camera; and
detecting position information on a position of the talker based on the obtained facial image of the talker, the detected position information including height information on the talker.

2. The talker position detection method according to claim 1, further comprising:
presenting a visual indication of the detected position information on a display unit.

3. The talker position detection method according to claim 1, further comprising:
receiving focus regions for at least one of the camera or the microphone,
wherein the obtaining obtains the obtained facial image based on a focus region that matches the determined direction information, among the received focus regions.

4. The talker position detection method according to claim 1, further comprising:
determining a focus region for at least one of the camera or the microphone based on the detected position information; and
presenting a visual indication of at least one of the determined focus region or a non-focus region, which does not correspond to the determined focus region, on a display unit.

5. The talker position detection method according to claim 1, further comprising:
determining a focus region for at least one of the camera or the microphone based on the detected position information; and
performing focus control for the at least one of the camera or the microphone based on the determined focus region.

6. The talker position detection method according to claim 5, wherein the focus control for the at least one of the camera or the microphone includes masking at least one of a facial image or a voice of a person other than the talker.

7. The talker position detection method according to claim 1, further comprising:
acquiring relative position information on a relative position of the camera and the microphone; and
determining a direction of the talker with respect to the image from the camera based on the acquired relative position information and the determined direction information, and
wherein the obtaining obtains the facial image of the talker from the image captured by the camera based on the determined direction of the talker with respect to the image from the camera.

8. The talker position detection method according to claim 1, further comprising:
acquiring relative position information on a relative position of the camera and the microphone, wherein the determined direction information includes an elevation angle and a horizontal angle relative to the microphone; and
determining an elevation angle, a horizontal angle, and an expansion amount for the camera based on the determined direction information, the acquired relative position information and the height information included in the detected position information.

9. The talker position detection method according to claim 1, wherein the detected position information includes information on positions of more than one talker.

10. The talker position detection method according to claim 1, further comprising:
detecting a start and an end of an event; and
resetting the detected position information upon detecting the end of the event,
wherein the determining determines renewed information on a direction of one talker, which is a new talker or the talker, based on a voice of the one talker, which is acquired concurrently upon detecting the start of a new event, such that the obtaining newly obtains a facial image of the one talker from the image captured by the camera based on the renewed information on the direction of the one talker and such that the detecting detects new position information on a position of the one talker based on the newly obtained facial image of the one talker, the new position information including new height information on the one talker.

11. The talker position detection method according to claim 10, further comprising:
detecting an environment of the event based on the voice acquired with the microphone and the image captured by the camera.

12. The talker position detection method according to claim 1, further comprising:
determining, on more than one occasion, a focus region for at least one of the camera or the microphone based on the detected position information; and
determining at least one of an averaged focus region or an averaged non-focus region based on the at least one of the determined focus region or a non-focus region, which does not correspond to the determined focus region, from the more than one occasion.

13. The talker position detection method according to claim 1, further comprising:
sensing a motion of the talker from the image captured by the camera; and
performing focus control for at least one of the camera or the microphone, according to the sensed motion of the talker.

14. The talker position detection method according to claim 1, wherein:
the detecting includes determining first position information on a position of a first talker and second position information on a position of a second talker,
the method further comprises:
determining a first focus region for at least one of the camera or the microphone based on the first position information;
determining a second focus region for the at least one of the camera or the microphone based on the second position information; and
setting a third focus region incorporating the determined first focus region and the determined second focus region, in a state where a predetermined condition is met.

15. A talker position detection apparatus comprising:
a microphone;
a camera; and
a processor configured to:
acquire a voice of a talker with the microphone;
determine direction information on a direction of the talker based on the acquired voice of the talker;
obtain a facial image of the talker based on the determined direction information and an image captured by the camera; and
detect position information on a position of the talker based on the obtained facial image of the talker, the detected position information including height information on the talker.

16. A non-transitory computer-readable storage medium storing a talker position detection program executable by at least one processor of an information processing device to execute a method comprising:
acquiring a voice of a talker with a microphone;
determining direction information on a direction of the talker based on the acquired voice of the talker;
obtaining a facial image of the talker based on the determined direction information and an image captured by a camera; and
detecting position information on a position of the talker based on the obtained facial image of the talker, the detected position information including height information on the talker.
